(19) United States
(12) Patent Application Publication
(10) Pub. No.: US 2009/0117901 A1
(43) Pub. Date: May 7, 2009

(54) METHOD AND DEVICE FOR CONFIGURING SERVICE PATHS IN RELAY SYSTEM AND METHOD OF MOBILE STATION HANDOVER

(76) Inventors: Quanbo Zhao, Shenzhen (CN); Ruobin Zheng, Shenzhen (CN)

Correspondence Address: BRINKS HOFER GILSON & LIONE, P.O. BOX 10395, CHICAGO, IL, 60610, US

(21) Appl. No.: 12/267,203

(22) Filed: Nov. 7, 2008

(30) Foreign Application Priority Data
Sep. 5, 2006 (CN) 200610060611.0
Apr. 19, 2007 (CN) PCT/CN2007/001283

(51) Int. Cl. H04W 36/00

(52) U.S. Cl. 455/436

(57) ABSTRACT

A method and apparatus for configuring service paths in a relay system, and a method for mobile station handover are provided. In the present invention, when it is determined that a mobile station is to be switched between a base station and a relay station attached thereto, or between different relay stations attached to the base station, the service paths are configured respectively between a handover source station and a mobile station and between a handover destination station and the mobile station and same data is transmitted by the base station. Therefore, this method facilitates the mobile station to ensure service continuity in the process of handover.

The present invention claims priority from the Chinese Patent Application No. 200610060611.0, entitled “Method for Configuring Service Paths in relay system and reliable handover of Mobile Stations”, filed with the Chinese State Intellectual Property Office on May 9, 2006, the entirety of which is incorporated herein by reference.

### FIELD OF THE INVENTION

The present invention relates to the technical field of wireless communication, more particularly to wireless communication technique with a relay system, and still more particularly to a method and device for configuring service paths in a relay system and a method for mobile station handover.

### BACKGROUND OF THE INVENTION

Broadband wireless access includes broadband fixed wireless access and broadband mobile wireless access. In a broadband fixed wireless access system, there are two kinds of network elements, i.e., base stations (BSs) and subscriber stations (SSs). In a broadband mobile wireless access system, there are two kinds of network elements, i.e., base stations (BSs) and mobile subscriber stations (MSSs). In addition, a concept of WiMAX relay system (RS) has been proposed. An important role of an RS is to serve as a relay between a BS and an SS/MSS so as to expand the coverage area of the BS or increase the throughput of the SS/MSS.

According to the relevant standards, for an authorized frequency band, a duplex mode can be a Frequency Division Dual (FDD) mode or a Time Division Dual (TDD) mode, and an SS in the FDD mode can be of half-duplex FDD; while for a frequency band free of authorization, a duplex mode can only be TDD. A frame structure of Orthogonal Frequency Division Multiplex Access (OFDMA) (or Scalable OFDMA) in the TDD mode is shown in FIG. 1. In an OFDMA (or SOFDMA) mode, a group of adjacent sub-channels and a set of OFDMA symbols are allocated for a Physical Layer (PHY) burst of OFDMA (or SOFDMA).

Data is transmitted in a frame format in a physical channel. Each frame includes a downlink sub-frame (DL sub-frame) and an uplink sub-frame (UL sub-frame). In the TDD mode, the UL sub-frame is transmitted firstly, the uplink sub-frame is transmitted subsequently. A burst can be allocated to an SS/MSS (or a group of subscribers) in the uplink, while transmitted by the BS as a transmission unit to the SS/MSS in the downlink. Initial access Ranging, periodicity Ranging and bandwidth requests of an uplink SS are performed through a Ranging sub-channel. A downlink sub-frame starts with a preamble for physical synchronization; a Frame Control Head (FCH) follows for designating the profile and length of one or more downlink bursts immediately following the FCH. Following the FCH is a downlink-MAP (DL-MAP) message and an uplink-MAP (UP-MAP) message. The DL-MAP indicates the sub-channel and OFDMA symbol position and profile of an individual downlink burst, while the UP-MAP indicates the sub-channel and OFDMA symbol position and profile of an individual uplink burst. In a TDD system, a transmit/receive transition gap (TTG) and a receive/transmit transition gap (RTG) are inserted at the time of alternating between a downlink sub-frame and an uplink sub-frame, so as to leave a period of time for the BS to accomplish transition between receiving and transmitting.

A frame structure of OFDMA (or SOFDMA) in the FDD mode differs from that in the TDD mode in that an uplink sub-frame and an downlink sub-frame are transmitted at different frequencies without setting the TTG and RTG.

According to related standards, definitions regarding handover are as follows:

(1) handover (HO): an MS moving from a service area of one BS to that of another BS. There are two kinds of handover defined as:
break-before-make HO: breaking connection with the original BS providing services before handover;
make-before-break HO: making handover before breaking connection with the original BS providing services.

(2) fast BS switching (FBSS): BS handover using a fast switching mechanism, in which the MS performs data transmitting/receiving only with an active BS (for example, an anchor BS), and the BS may be different for each frame, which depends on the BS selecting mechanism.

(3) soft handover (SHO): the process that an MS migrates from a service area of one or more BSs to that of other one or more BSs. In such a process, in the downlink direction, two or more BSs transmit Packet Data Units (PDUs) of a same Media Access Control (MAC)/PHY, and combination of the PDUs is accomplished by the MS; while in the uplink direction, two or more BSs can receive a same PDU from the MS, so that diversity combination can be accomplished between the BSs.

In the bandwidth allocation model of a relay system, bandwidth allocation (BW allocation) is only implemented in an anchor BS, and the anchor BS allocates the uplink and downlink bandwidths respectively for a BS and an RS. Service dispatching is mainly implemented in the BS, and the RS just dispatches uplink and downlink services of the RS passively as instructed by the BS. Specifically, there are two different modes as follows:

(1) After the BS allocating the uplink and downlink bandwidths for the BS and the RS, the position and profile of each burst to the respective connection of the SS/MSS attached to the RS are specified in a Relay Information Element (Relay-IE) of a DL-MAP message and a UL-MAP message sent by the BS. As shown in FIG. 2, the Relay-IE is a newly added Information Element (IE) in the DL-MAP and UL-MAP messages, and can be regarded as an expanded Map Information Element (MAP-IE) in the DL-MAP and UL-MAP messages for defining the position and profile of each burst of the respective connection of the SS/MSS attached to the RS.

(2) Bandwidth Grant (BW Grant) is implemented by specifying the position and profile of each burst of the respective connection of the SS/MSS attached to the RS in a MAP-IE of a Relay Station DL-MAP (DL-MAP (RS)) message and a Relay Station UL-MAP (UL-MAP (RS)) message sent by the BS. As shown in FIG. 3, a DL-MAP (RS) message and a UL-MAP (RS) message are newly added management messages from the BS to the RS positioned in a downlink sub-frame in the PHY frame structure of the BS. The MAP-IE defines the position and profile of each burst of the respective connection of the SS/MSS attached to the RS.

In addition, two types of relay models are defined in an existing relay system, one is a high-level relay mode, i.e., an MS/SS accesses a BS through wireless relaying performed by an RS; another is a simplified relay mode, i.e., downlink datagram of a BS or messages except DL-MAP messages and UL-MAP messages can be relayed by an RS, while other uplink bursts of the BS except initial access Ranging, periodicity Ranging and bandwidth request messages of an MS/SS can be relayed by the RS.

Although in existing standards, concepts of BS, MS and RS have been defined, and the two kinds of Relay models for a relay system have been proposed, the specific implementation of handover of an MS within a BS and involving an RS is not defined, which results in poor service continuity and poor handover reliability in the process of MS handover.

### SUMMARY OF THE INVENTION

A method and apparatus for configuring service paths in a relay system and a method for reliable handover of an MS is provided in embodiments of the present invention to improve the continuity and reliability of the handover process of an MS within a BS, with respect to an RS.

A method for configuring service paths in a relay system is provided in an embodiment of the present invention, including:

configuring the service paths respectively between a handover source station and an MS and between a handover destination station and the MS when it is determined that the MS needs to be switched between a BS and an attached RS or between different RSs attached to a BS, and transmitting same data; and

implementing combined reception of data according to receiving situations of the two paths, and transmitting same data in the two paths.

An apparatus for configuring service paths in a relay system is provided in an embodiment of the present invention, including:

a determining unit adapted to determine whether an MS needs to be switched or not, the switching including switching between a BS and an attached RS or switching between different RSs attached to a BS; and

a configuring unit adapted to configure the service paths; in which:

when the determining unit determines that the MS needs to be switched between a BS and an RS attached thereto, or between different RSs attached to a BS, the configuring unit configures the service paths respectively between a handover source station and the MS and between a handover destination station and the MS.

A handover method of an MS in a relay system is provided in an embodiment of the present invention, including:

initiating a handover process when it is determined that the MS needs to be switched between a BS and an RS attached thereto, or between different RSs attached to a BS;

configuring, by the BS, service paths respectively between a handover source station and the MS and between a handover destination station and the MS; and

switching the MS based on the configured service paths.

In the technical solution provided in the embodiments of the present invention, when an MS is switched between a BS and an RS attached thereto or between different RSs attached to the BS, service paths are configured respectively between a handover source station and the MS and between a handover destination station and the MS, so as to ensure service continuity in the process of handover of the MS, and to improve handover reliability. Furthermore, in this solution, an uplink and downlink MAP-IE of a BS or different RSs can be re-mapped into a same burst block position to save bandwidth.

### BRIEF DESCRIPTION OF THE DRAWINGS

FIG. 1 is a schematic diagram of the OFDMA (or SOFDMA) frame structure in a TDD mode in the prior art;

FIG. 2 is a schematic diagram of the OFDMA (or SOFDMA) frame structure of a BS in a TDD relay system in the prior art;

FIG. 3 is another schematic diagram of the OFDMA (or SOFDMA) frame structure of a BS in a TDD relay system in the prior art;

FIG. 4 is a schematic diagram showing MS handover in a first case (MS is switched between a BS and an RS attached thereto) according to an embodiment of the present invention;

FIG. 5 is a schematic diagram showing MS handover in a second case (MS is switched between different RSs attached to a BS) according to an embodiment of the present invention;

FIG. 6 is a schematic diagram showing the principle of realizing that the BS employs unicast mode and relay data parameters are indicated by Relay-IE in a first embodiment of the present invention;

FIG. 7 is a schematic diagram showing the principle of realizing that the BS employs unicast mode and relay data parameters are indicated by DL-MAP (RS) and UL-MAP (RS) in the first embodiment of the present invention;

FIG. 8 is a schematic diagram showing the principle of realizing that the BS employs multicast mode and relay data parameters are indicated by Relay-IE in a first embodiment of the present invention;

FIG. 9 is a schematic diagram showing the principle of realizing that the BS employs multicast mode and relay data parameters are indicated by DL-MAP (RS) and UL-MAP (RS) in the first embodiment of the present invention;

FIG. 10 is a schematic diagram showing the principle of realizing that a dedicated relay area is already allocated in a frame structure and relay data parameters are indicated by Relay-IE in a first embodiment of the present invention;

FIG. 11 is a schematic diagram showing the principle of realizing that a dedicated relay area is already allocated in a frame structure and relay data parameters are indicated by DL-MAP (RS) and UL-MAP (RS) in the first embodiment of the present invention;

FIG. 12 is a schematic diagram showing the principle of realizing that the BS employs unicast mode and relay data parameters are indicated by Relay-IE in a third embodiment of the present invention;

FIG. 13 is a schematic diagram showing the principle of realizing that the BS employs unicast mode and relay data parameters are indicated by DL-MAP (RS) and UL-MAP (RS) in the third embodiment of the present invention;

FIG. 14 is a schematic diagram showing the principle of realizing that the BS employs unicast mode and relay data parameters are indicated by Relay-IE in a fourth embodiment of the present invention;

FIG. 15 is a schematic diagram showing the principle of realizing that the BS employs unicast mode and relay data parameters are indicated by DL-MAP (RS) and UL-MAP (RS) in the fourth embodiment of the present invention;

FIG. 16 is a schematic diagram showing the principle of realizing that the BS employs unicast mode and relay data parameters are indicated by Relay-IE in a fifth embodiment of the present invention;

FIG. 17 is a schematic diagram showing the principle of realizing that the BS employs unicast mode and relay data parameters are indicated by DL-MAP (RS) and UL-MAP (RS) in the fifth embodiment of the present invention;

FIG. 18 is a flowchart showing hard handover for an MS in an embodiment of the present invention; and

FIG. 19 is a flowchart showing soft handover (SHO) for an MS in an embodiment of the present invention.

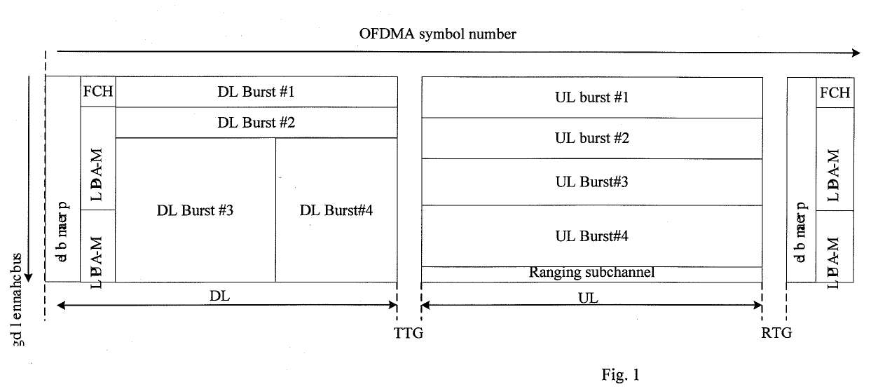

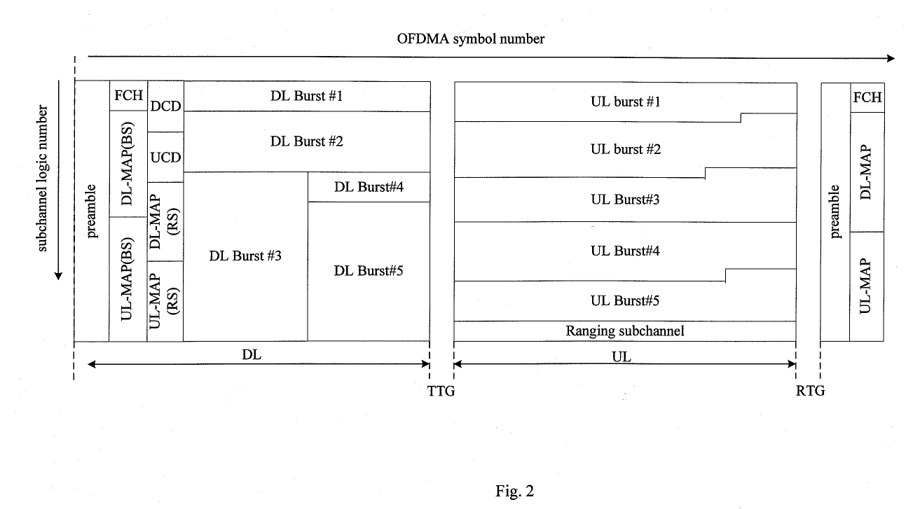

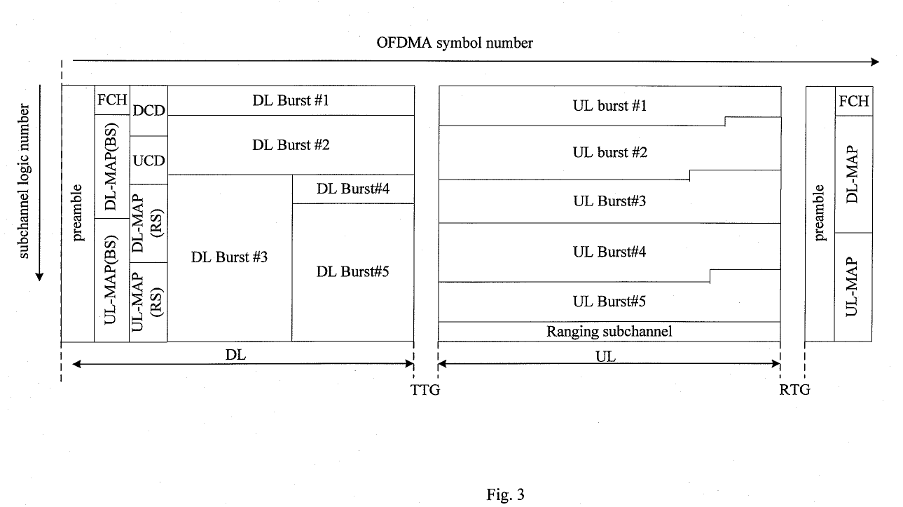

### DETAILED DESCRIPTION OF THE INVENTION

Hereinafter, the present invention is described by specific embodiments with reference to the accompanied drawings to make the principle, the features, and advantages of the present invention more apparent.

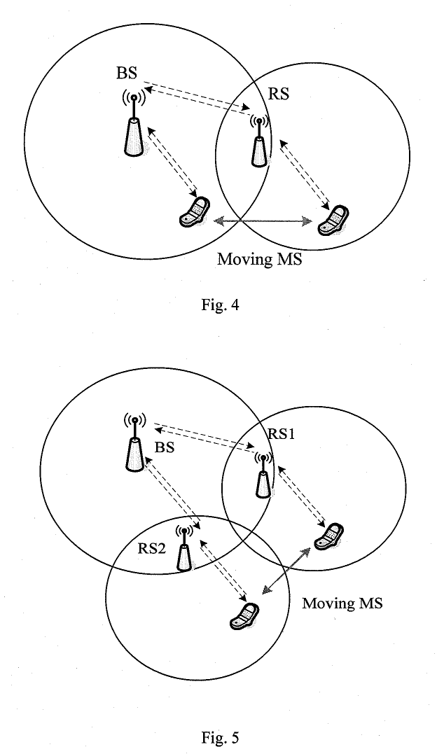

As shown in FIG. 4, in a first case of MS handover, the BS allocates two service connections with same QoS for each of the downlink and the uplink of the MS in the process of switching the MS to a BS from an RS attached thereto, or from a BS to an RS attached thereto, so as to ensure that respective bandwidth is allocated for the MS both in the source BS and the destination BS. In the process of handover, there are two service paths at the same time between the MS and the BS, one is a direct path between the MS and the BS, another is a relay path passing through the RS.

In order to be distinguished, hereinafter different IEs will be described on the senders and receivers of the burst blocks indicated by the IEs, for example, a BS-RS IE indicates an IE specifying a parameter of a burst block sent from a BS to an RS, i.e., an IE in a DL-MAP message; an RS-MS IE indicates an IE specifying a parameter of a burst block sent from an RS to an MS, which may be a Relay-IE in a UL-MAP or a DL-MAP message, or an IE in a UL-MAP (RS) or a DL-MAP (RS) message.

The description presented in the embodiments is illustrated here:

BS downlink direction indicates a direction in which a BS sends data to its direct underling (RS or MS);

BS uplink direction indicates a direction in which a direct underling (RS or MS) of a BS sends data to the BS;

RS downlink direction indicates a direction in which an RS sends data to its direct underling (MS);

RS uplink direction indicates a direction in which a direct underling (MS) of an RS sends data to the RS.

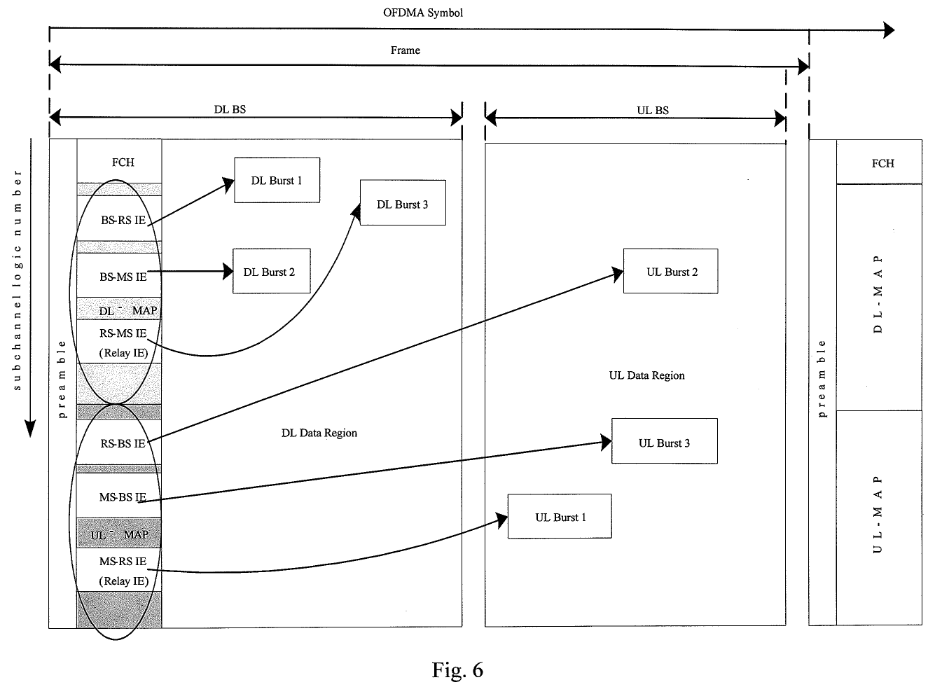

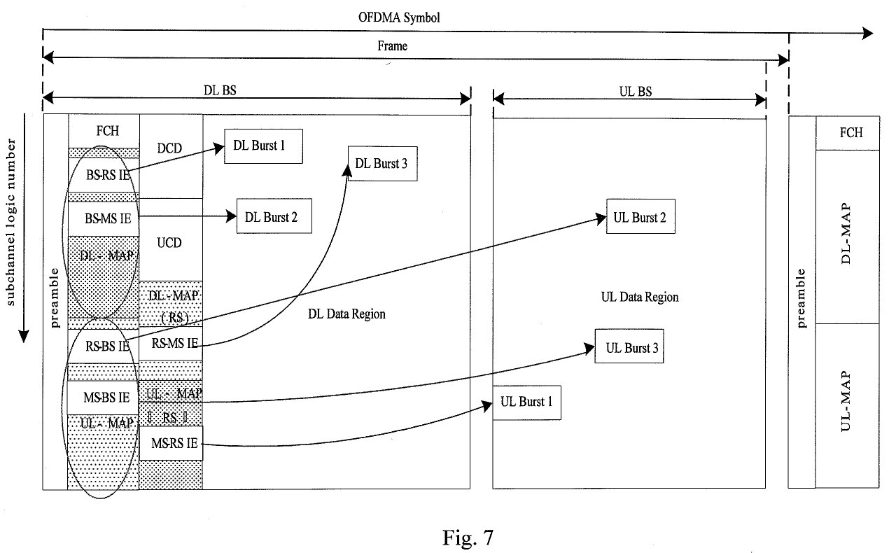

As shown in FIGS. 6 and 7, in a first embodiment of the present invention, a solution for implementing handover is as follows:

1) In the BS downlink direction, the BS sends same data to the RS and the MS respectively, and uses a BS-RS IE and a BS-MS IE respectively in the DL-MAP to indicate burst blocks in different positions. The RS receives downlink data according to the BS-RS IE indication, and the MS receives downlink data according to the BS-MS IE indication;

2) In the BS uplink direction, the BS uses an RS-BS IE and an MS-BS IE respectively in the UL-MAP to indicate burst blocks in different positions. The RS sends uplink data according to the RS-BS IE indication, and the MS sends uplink data according to the MS-BS IE indication.

3) In the RS downlink direction, a relay data parameter forwarded by the RS to the MS can be indicated by a Relay-IE in the DL-MAP (RS) or DL-MAP in the BS frame structure, and define the position and profile of each burst in the respective MS downlink connection passing through the RS. According to different RS relay modes, the MS retrieves a relay parameter in two ways: (a) high-level relay mode, where the relay parameter of the MS is retrieved through the RS relaying; (b) simplified relay mode, where only relayed data pass through the RS, the relay parameter of the MS is retrieved by receiving the respective position of the BS frame.

4) In the RS uplink direction, a relay data parameter to be forwarded by the RS from the MS to the BS can be indicated by the Relay-IE in the UL-MAP (RS) or UL-MAP; and define the position and the profile of each burst in the respective MS uplink connection passing through the RS.

With this solution, the BS needs to allocate bandwidths both for the RS and the MS (for example, occupying different sub-channels).

As shown in FIG. 6, the BS employs a unicast mode, and the relay data parameters forwarded by the RS to the MS and BS are indicated by the Relay-IE in the DL-MAP and UL-MAP. DL-burst1, DL-burst2 and DL-burst3 are data blocks respectively sent from the BS to the RS, from the BS to the MS, and from the RS to the MS, in which DL-burst2 and the DL-burst3 should be data blocks with same contents, while DL-burst1 should contain at least the contents of DL-burst2 and DL-burst3 (because the RS may have data from other MSs to relay). UL-burst1, UL-burst2 and UL-burst3 are data blocks respectively sent from the MS to the RS, from the RS to the BS and from the MS to the BS, in which UL-burst1 and the UL-burst3 should be data blocks with same contents, while UL-burst2 should contain at least the contents of UL-burst1 and UL-burst3 (because the RS may have data from other MSs to relay).

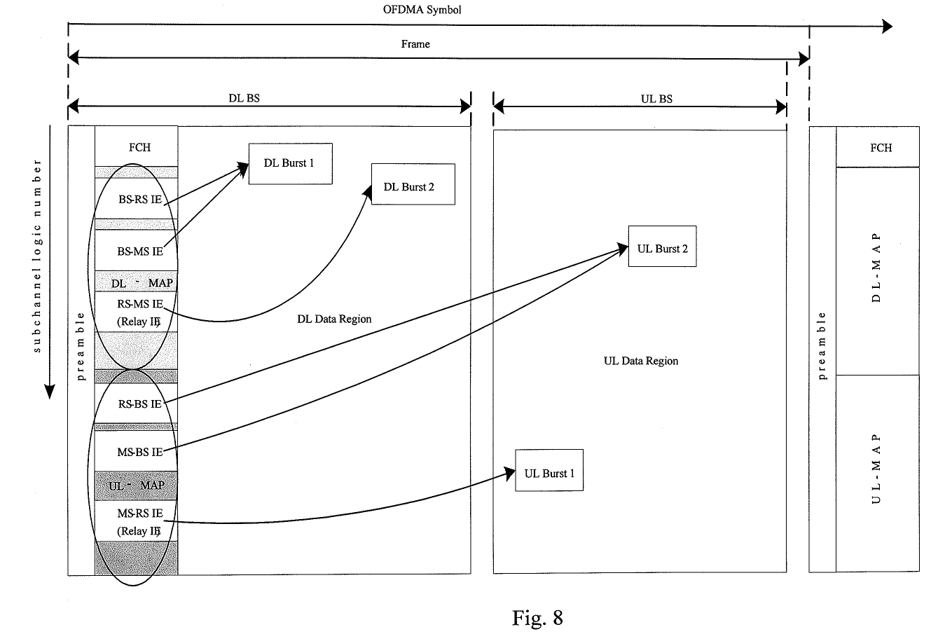

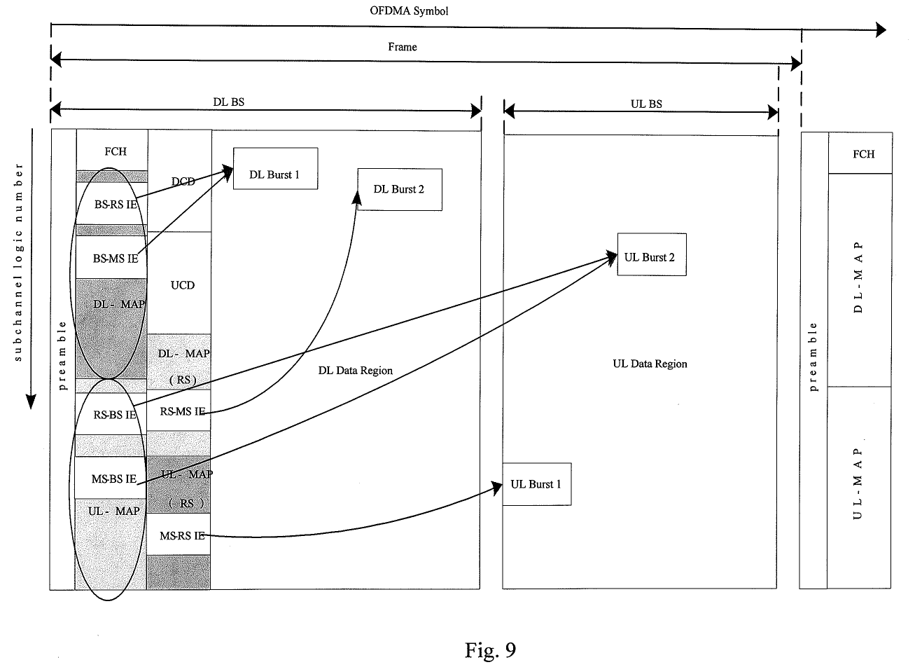

As shown in FIG. 7, the BS employs a unicast mode, and the relay data parameters forwarded by the RS to the MS and BS are indicated by the DL-MAP (RS) and UL-MAP (RS). Contents of other data blocks are the same as that in FIG. 6. As shown in FIGS. 8 and 9, in a second embodiment of the present invention, solution for implementing handover is as follows:

1) In the BS downlink direction, the BS sends only one set of data, the BS-RS IE and the BS-MS IE in the DL-MAP indicate the burst block at a same position for the RS and the MS to receive at the same position. The RS receives downlink data according to the BS-RS IE indication, and the MS receives downlink data according to the BS-MS IE indication;

2) In the BS uplink direction, the BS employs the RS-BS IE and the MS-BS IE in the UL-MAP respectively to indicate the burst block at a same position. The RS sends uplink data according to the RS-BS IE indication, and the MS sends uplink data according to the MS-BS IE indication;

3) The relay data parameters between the RS and the MS are set in the same way as that in the first embodiment.

Compared with the first embodiment, the RS and the MS in this embodiment obtain the same bandwidths, but occupy the BS bandwidth by only half of that in the first embodiment.

As shown in FIG. 8, the BS employs a multicast mode, and relay data parameters forwarded by the RS to the MS and BS are indicated by the Relay-IE in the DL-MAP and UL-MAP.

As shown in FIG. 9, the BS employs a multicast mode, and relay data parameters forwarded by the RS to the MS and BS are indicated by the DL-MAP (RS) and UL-MAP (RS).

In addition to the first and second embodiments, in the first case of handover, it is also possible to re-map only the BS-RS IE and BS-MS IE in the BS downlink DL-MAP, or re-map only the RS-BS IE and MS-BS IE in the BS uplink UL-MAP.

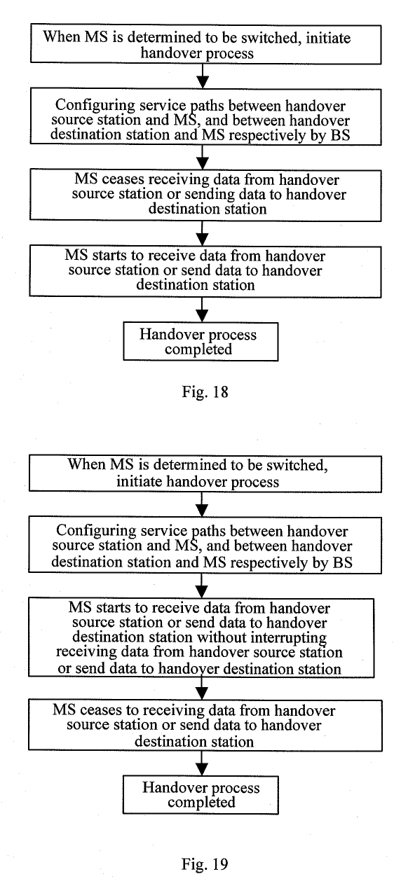

As shown in FIGS. 18 and 19, in the first and the second embodiments for the first case of handover, a basic handover flow exemplified by an MS switching from an RS to a BS is as follows:

1) Before handover, the MS receives data blocks forwarded by the RS according to the DL-MAP (Relay-IE) or the DL-MAP (RS) indication received directly from the BS or relayed by the RS; and sends data blocks to the RS according to the DL-MAP (Relay-IE) or the DL-MAP (RS) indication received directly from the BS or relayed by the RS.

2) The handover process is initiated, the BS ensures that there are two service paths between the BS and the MS, such as, in the downlink direction: (a) BS→RS, RS→MS; (b) BS→MS; and in the uplink direction, (a) MS→RS, RS→BS; (b) MS→BS; (for hard handover (FBSS):)

3) The MS ceases receiving data from or sending data to the RS firstly;

4) The MS starts to receive data or send data to the BS directly;

5) The handover process is completed.

(for soft handover (SHO):)

3) The MS receives data from or sends data to the BS directly without interrupting receiving data from or sending data to the RS;

4) The MS interrupts receiving data from or sending data to the RS;

5) The handover process is completed.

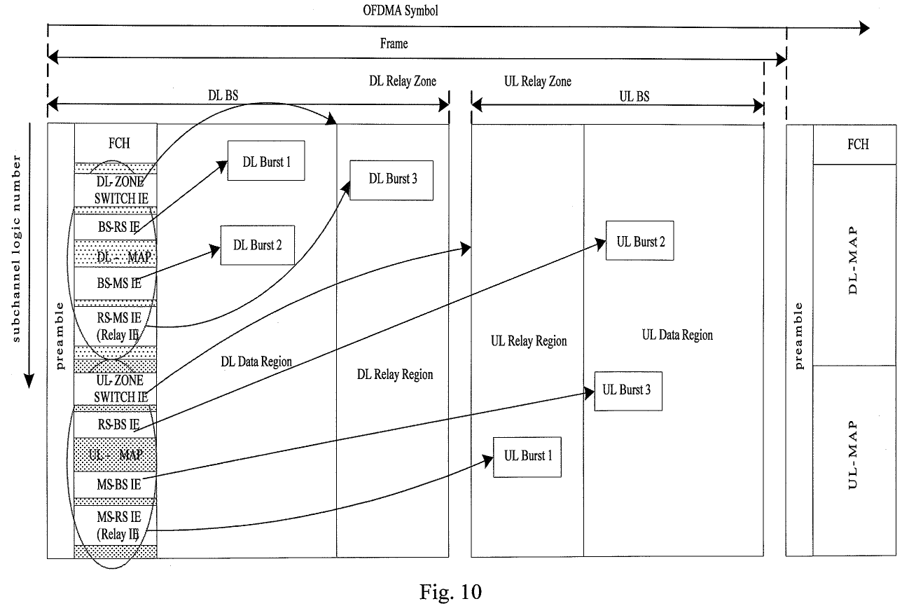

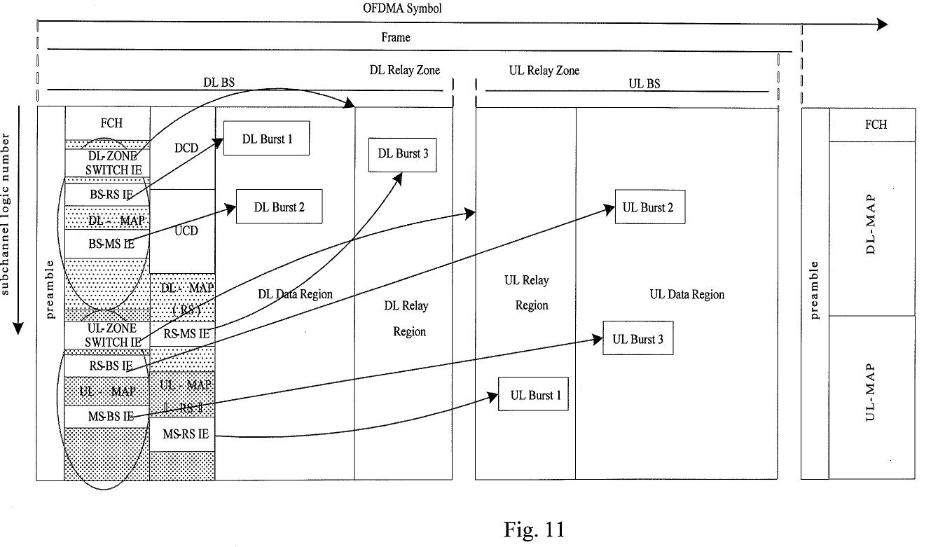

FIGS. 10 and 11 show another solution of the present invention where a dedicated Relay Zone is already allocated in the frame structure, and other embodiments are similar to this. DL-ZONE SWITCH IE indicates the starting position of a DL Relay Zone, and UL-ZONE SWITCH IE indicates the starting position of a UL Relay Zone. Data relayed by the RS to the MS presents in the DL Relay Zone, and data from the MS relayed by the RS to the BS presents in the UL Relay Zone.

As shown in FIG. 5, in the second case of MS handover, the MS moves to switch from RS1 to RS2. Similar to the processing in the first case of handover, the BS needs to ensure that same connection bandwidths are available in both the handover source station (RS1) and the handover destination station (RS2) to be allocated to the MS during the MS handover process. In the process of handover, there are two service paths exist between the MS and the BS, one is a relay path passing through the RS1, and another is a relay path passing through the RS2.

Embodiments of the present invention also provide an apparatus for configuring service paths in a relay system. The apparatus includes: a determining unit adaped to determine whether an MS needs handover or not, the handover including handover between a BS and an attached RS or handover between different RSs attached to a BS;

a configuring unit adapted to configure the service paths; in which:

when the determining unit determines that the MS needs handover between a BS and an RS attached thereto, or between different RSs attached to a BS, the configuring unit configures service paths respectively between a handover source station and the MS and between a handover destination station and the MS.

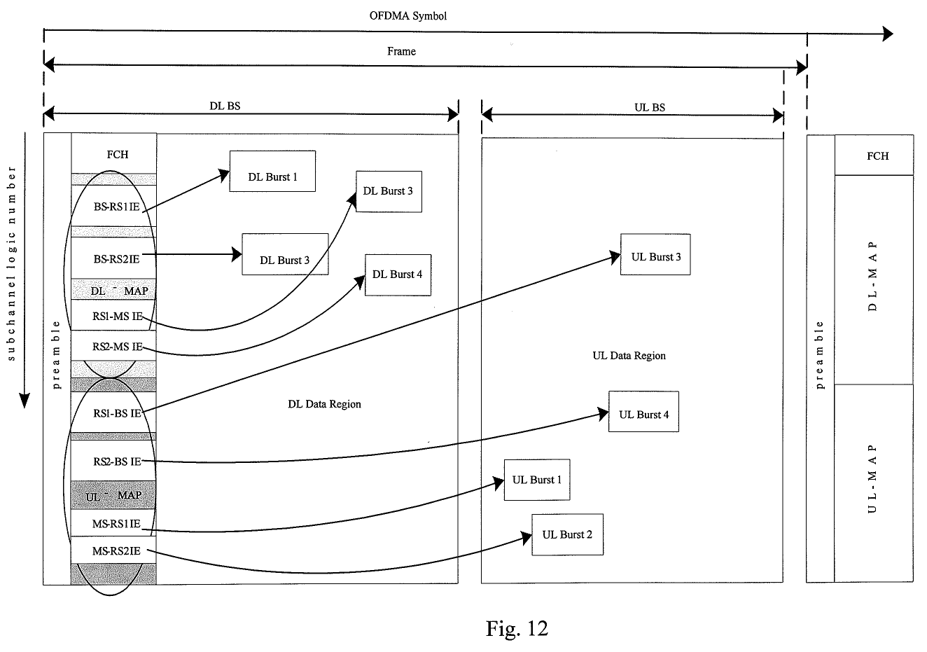

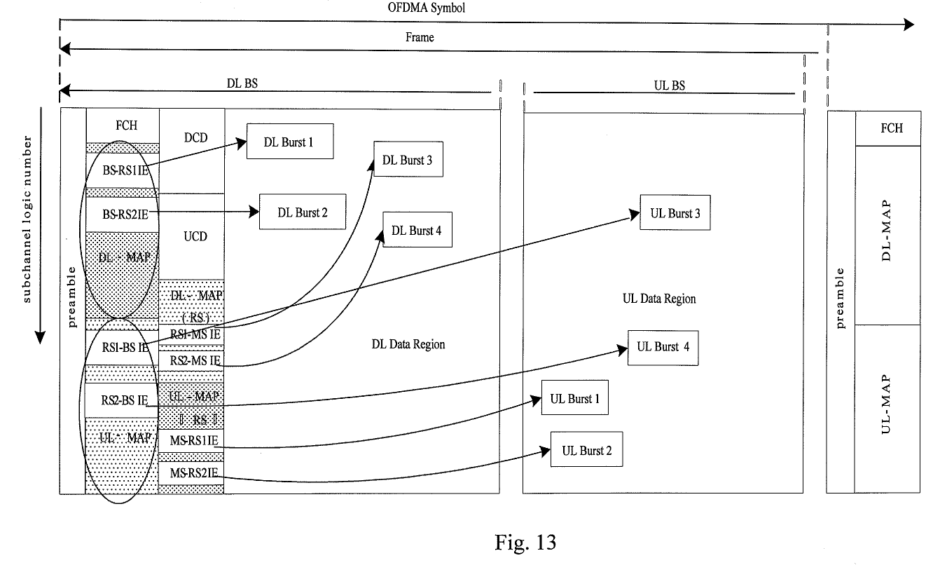

As shown in FIGS. 12 and 13, in a third embodiment of the present invention, solution for implementing handover is as follows:

1) In the BS downlink direction, the BS-RS1 IE and the BS-RS2 IE in the DL-MAP indicate burst blocks at different positions respectively, i.e., the BS sends same data to the RS1 and the RS2 respectively. The RS1 receives downlink data according to the BS-RS1 IE indication, and the RS2 receives downlink data according to the BS-RS2 IE indication;

2) In the BS uplink direction, the BS employs the RS1-BS IE and the RS2-BS IE in the UL-MAP to indicate burst blocks at different positions respectively. The RS1 sends uplink data according to the RS1-BS IE indication, and the RS2 sends uplink data according to the RS2-BS IE indication;

3) In the RS downlink direction, relay data parameters forwarded to the MS by the RS1 and the RS2 can be indicated by the Relay-IE in the DL-MAP (RS) or the DL-MAP in the BS frame structure, and point at burst blocks at different positions which is received in diversity combination by the MS. The MS retrieves the relay parameters in two ways depending on the different RS relay modes: (a) in a high-level relay mode, the relay parameters of the MS are retrieved through RS relaying; (b) in a simplified relay mode, only relay data pass through the RS, the relay parameters of the MS are retrieved through receiving respective positions of the BS frame by the MS;

4) In the RS uplink direction, relay data parameters from the MS to be relayed by the RS1 and the RS2 to the BS can be indicated by the Relay-IE in the UL-MAP (RS) and the UL-MAP in the BS frame structure, and point at burst blocks at different positions; the MS needs to send two same sets of data.

As shown in FIG. 12, the BS-RS1 in the DL-MAP indicates the position of each burst in the respective connection of the MS attached to the RS1 in the downlink direction; the BS-RS2 IE in the DL-MAP indicates the position of each burst in the respective connection of the MS attached to the RS2 in the downlink direction; the RS1-BS IE in the UL-MAP indicates the position of each burst in the respective connection of the MS attached to the RS1 in the uplink direction; the RS2-BS IE in the UL-MAP indicates the position of each burst in the respective connection of the MS attached to the RS2 in the uplink direction. The DL-burst1, DL-burst2, DL-burst3 and DL-burst4 are data blocks sent respectively from the BS to the RS1, from the BS to the RS2, from the RS1 to the MS and from the RS2 to the MS. The DL-burst3 and DL-burst4 should be data blocks with same contents, and the DL-burst1 and DL-burst2 should contain at least the contents of the DL-burst3 and DL-burst4 (because the RS1 and the RS2 may have data from other MSs to relay). The UL-burst1, UL-burst2, UL-burst3 and UL-burst4 are data blocks sent respectively from the MS to the RS1, from the MS to the RS2, from the RS1 to the BS and from the RS2 to the BS. The UL-burst1 and UL-burst2 should be data blocks with same contents, and the UL-burst3 and the UL-burst4 should contain at least the contents of the UL-burst1 and UL-burst2 (because the RS1 and RS2 may have data from other MSs to relay).

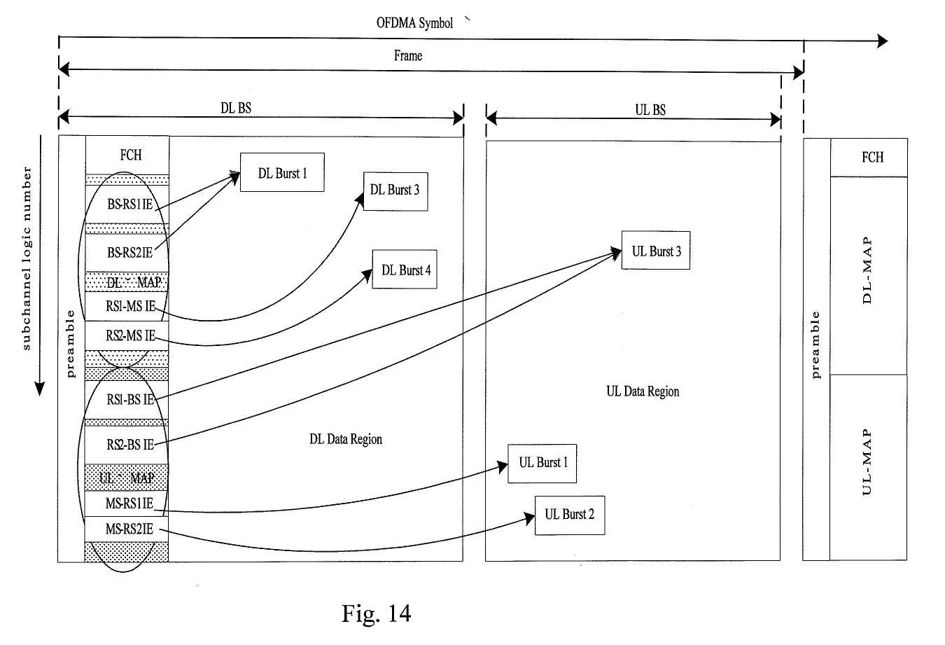

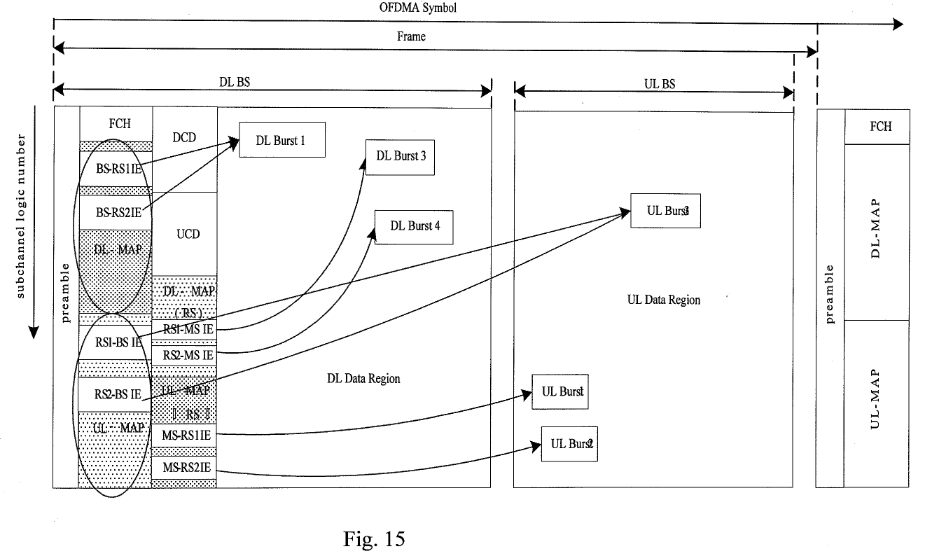

As shown in FIGS. 14 and 15, in a fourth embodiment of the present invention, solution for implementing handover is as follows:

1) In the BS downlink direction, the BS sends only one set of data, the BS-RS1 IE and the BS-RS2 IE in the DL-MAP indicate the burst block at a same position for the RS1 and the RS2 to receive at the same position. The RS1 receives downlink data according to the BS-RS1 IE indication, and the RS2 receives downlink data according to the BS-RS2 IE indication;

2) In the BS uplink direction, the BS employs the RS1-BS1 IE and the RS2-BS IE in the UL-MAP to indicate the burst block at a same position. The RS1 sends uplink data according to the RS1-BS IE indication, and the RS2 sends uplink data according to the RS2-BS IE indication;

3) The relay data parameters between the RS and the MS are set in a same way as that in the third embodiment.

Compared with the third embodiment, the RS1 and the RS2 obtain the same bandwidths, but occupy the BS bandwidth by only half of that in the third embodiment.

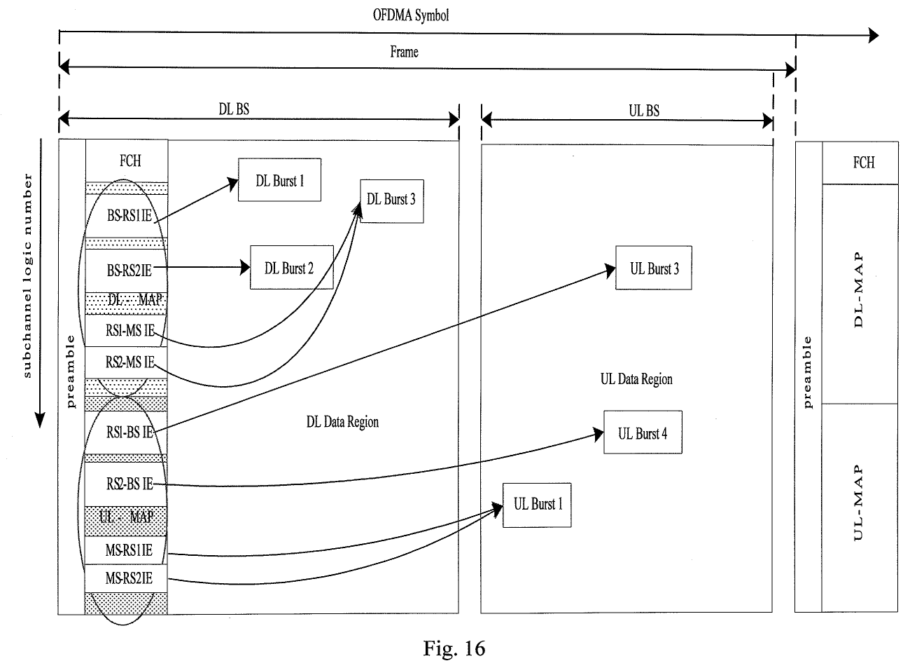

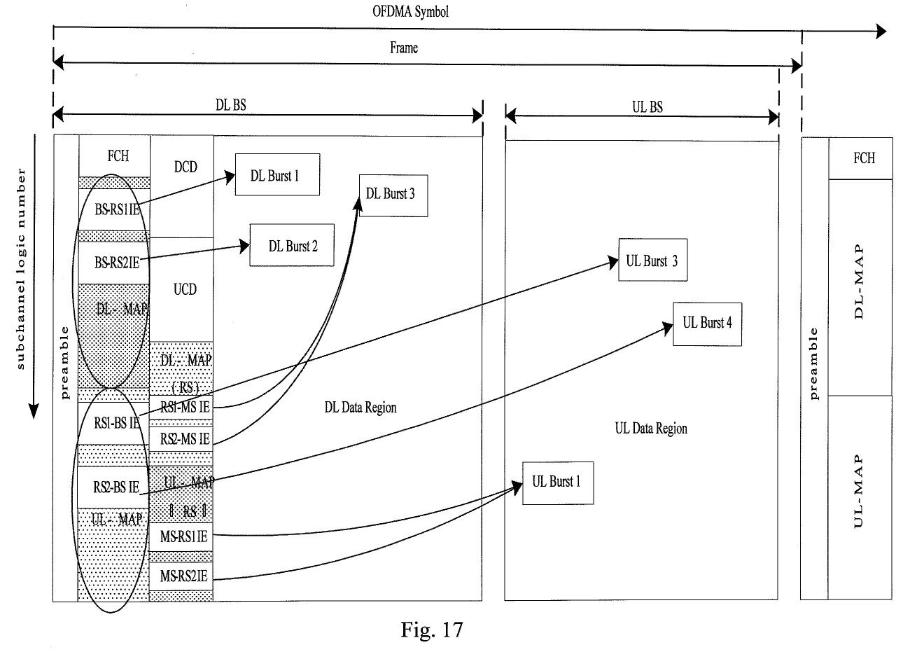

As shown in FIGS. 16 and 17, in a fifth embodiment of the present invention, solution for implementing handover is as follows:

1) In the BS downlink direction, the BS-RS1 and the BS-RS2 in the DL-MAP indicate burst blocks respectively at different positions, i.e., the BS sends same data to the RS1 and RS2 respectively. The RS1 receives downlink data according to the BS-RS1 IE indication, and the RS2 receives downlink data according to the BS-RS2 IE indication;

2) In the BS uplink direction, the BS employs the RS1-BS IE and the RS2-BS IE in the UL-MAP to indicate burst blocks at different positions. The RS1 sends uplink data according to the RS1-BS IE indication, and the RS2 sends uplink data according to the RS2-S IE indication;

3) In the RS downlink direction, relay data parameters forwarded by the RS1 and RS2 to the MS can be indicated by the Relay-IE in the DL-MAP (RS) or the DL-MAP in the BS frame structure, and points at the burst block at a same position, which is received in diversity combination by the MS;

4) In the RS uplink direction, relay data parameters from the MS forwarded by the RS1 and the RS2 to the BS can be indicated by the Relay-IE in the UL-MAP (RS) or the UL-MAP in the BS frame structure, and points at the burst block at a same position. The MS needs to send two same sets of data.

In addition to the third, fourth and fifth embodiments, in the second case of handover, the solution may also include other combinations of the following four aspects: (1) whether the BS-RS1 IE and the BS-RS2 IE in the BS downlink are re-mapped or not; (2) whether the RS1-BS IE and the RS2-BS IE in the BS uplink are remapped or not; (3) whether the RS1-MS IE and the RS2-MS IE in the RS downlink are re-mapped or not; and (4) whether the MS-RS1 IE and the MS-RS2 IE in the RS uplink are re-mapped or not.

FIGS. 18 and 19 show respectively the handover flows for hard handover and the soft handover performed by the MS in embodiments of the present invention. As exemplified by the MS switching from the RS1 to the RS2 in the second case of handover, the basic handover flow is as follows:

1) before handover, the MS receives data blocks forwarded by the RS1 according to the DL-MAP (Relay-IE) or the DL-MAP (RS) indication directly received from the BS or relayed by the RS1; and sends data blocks to the RS1 according to the DL-MAP (Relay-IE) or the DL-MAP (RS) indication directly received from the BS or relayed by the RS1;

2) the handover process is initiated, the BS ensures that there are two service paths between the BS and the MS, such as, in the downlink direction: (a) BS→RS1, RS1→MS; (b) BS→RS2, RS2→MS; in the uplink direction, (a) MS→RS1, RS1→BS; (b) MS→RS2, RS2→BS;

(for hard handover (FBSS):)

3) The MS ceases receiving data from or sending data to the RS1 firstly;

4) The MS starts to receive data from or send data to the RS2 directly;

5) The handover process is completed.

(for soft handover (SHO):)

3) The MS receives data from or sends data to the RS2 directly without interrupting receiving data from or sending data to the RS1;

4) The MS interrupts receiving data from or sending data to the RS1;

5) The handover process is completed.

In the embodiment, when a dedicated Relay Zone is already allocated in the frame structure, operation is similar to that in the first embodiment. A DL-ZONE SWITCH IE is appended in the DL-MAP message to indicate the starting position of a DL Relay Zone, and a UL-ZONE SWITCH IE is appended in the UL-MAP message to indicate the starting position of a UL Relay Zone. Data forwarded by the RS1 or RS2 to the MS present in the DL Relay Zone, data to be relayed by RS1 or RS2 from the MS to the BS present in the UL Relay Zone.

In the technical solution provided by the embodiments of the present invention, when an MS switches between a BS and an RS attached thereto, or between different RSs attached to a BS, service paths are configured by the BS respectively between the handover source station and the MS, and between the handover destination station and the MS, so as to ensure service continuity in the MA handover process and improve the handover reliability. Furthermore, in this method, the downlink and uplink map information elements may be re-mapped to a same burst block position to save bandwidth.

The above embodiments are used for illustrating and explaining the principle of the present invention. It should be appreciated that the present invention is not limited to those embodiments. For those skilled in the art, various alterations and modifications without departing from the substance and the range of the present invention should be covered by the protection scope of the present invention.

What is claimed is:

1. A method for configuring service paths in a relay system, comprising:
configuring the service paths respectively between a handover source station and a mobile station and between a handover destination station and the mobile station and transmitting same data when it is determined that the mobile station is to be switched between a base station and a relay station attached to the base station, or between different relay stations attached to the base station; and
implementing combined reception of data according to receiving situations of the two paths, and transmitting the same data in the two paths.

2. The method according to claim 1, wherein, when the mobile station is to be switched between the base station and the relay station attached to the base station, the base station configures the service paths as follows:
in the base station downlink direction, the base station sends same data to the relay station and the mobile station, and employs different map information elements in a downlink map message of a base station frame structure to indicate parameters of burst blocks sent from the base station respectively to the relay station and the mobile station attached to the base station;
in the base station uplink direction, different map information elements in a uplink map message of a base station frame structure are employed to indicate parameters of burst blocks sent to the base station respectively from the relay station and the mobile station attached to the base station;
in the relay station downlink direction, relay data parameters forwarded by the relay station to the mobile station are indicated by an information element in a relay station downlink map message or a relay information element in a downlink map message of a base station frame structure; and
in the relay station uplink direction, relay data parameters forwarded by the relay station from the mobile station to the base station are indicated by an information element in a relay station uplink map message or a relay information element in an uplink map message of a base station frame structure.

3. The method according to claim 2, wherein, the parameters of the burst blocks point at burst blocks at a same position or different positions.

4. The method according to claim 1, wherein, when the mobile station is to be switched between different relay stations attached to the base station, the service paths are configured as follows:
in the base station downlink direction, the base station sends same data to related relay stations, and employs different map information elements in a downlink map message of a base station frame structure to indicate parameters burst blocks sent from the base station respectively to the different relay stations attached to the base station;
in the base station uplink direction, different map information elements in a uplink map message of the base station frame structure are employed to indicate parameters of burst blocks sent to the base station respectively from related relay stations attached to the base station;
in the relay station downlink direction, information elements in the relay station downlink map message or relay information elements in the downlink map message are employed to indicate relay data parameters forwarded by different relay stations to the mobile station; and
in the relay station uplink direction, information elements in the relay station downlink map message or relay information elements in the downlink map message are employed to indicate relay data parameters forwarded by the different relay stations from the mobile station to the base station.

5. The method according to claim 4, wherein the parameters of the burst blocks point at burst blocks at a same position or different positions.

6. The method according to any one of claims 1, 2 and 4, wherein a dedicated relay zone is allocated in the frame structure,
the downlink map message further comprises a downlink zone switching information element for indicating a start position of the downlink relay zone;
the uplink map message further comprises an uplink zone switching information element for indicating a start position of the uplink relay zone;
data relayed by the relay station to the mobile station presents in the downlink relay zone, and data relayed by the relay station to the base station presents in the uplink relay zone.

7. An apparatus for configuring service paths in a relay system, comprising:
a determining unit adapted to determine whether a mobile station needs to be switched or not, wherein the switching comprises switching between a base station and a relay station attached to the base station or switching between different relay stations attached to the base station; and
a configuring unit adapted to configure service paths; wherein
when the determining unit determines that the mobile station needs to be switched between the base station and a relay station attached to the base station, or between the different relay stations attached to the base station, the configuring unit configures service paths respectively between a handover source station and the mobile station and between a handover destination station and the mobile station.

8. A method for mobile station handover in a relay system comprising:
initiating, by a mobile station, a handover process when it is determined that the mobile station needs to be switched between a base station and a relay station attached to the base station, or between different relay stations attached to the base station;
configuring, by the base station, service paths respectively between a handover source station and the mobile station and between a handover destination station and the mobile station; and
switching the mobile station based on the configured service paths.

9. The method according to claim 8, wherein, if the mobile station handover is hard handover, the handover process comprises:
after ceasing receiving data from or sending data to the handover source station, the mobile station starting to receive data from or send data to the handover destination station, so as to complete the handover process.

10. The method according to claim 8, wherein, if the mobile station handover is soft handover, the handover process comprises:
after starting to receive data from or send data to the handover destination, the mobile station ceasing receiving data from or sending data to the handover source station, so as to complete the handover process.

11. The method according to claim 8, wherein, when the mobile station is to be switched between the base station and the relay station attached to the base station, the service paths are configured as follows:
in the base station downlink direction, the base station sends same data to the relay station and the mobile station, and different map information elements in a downlink map message of a base station frame structure are employed to indicate parameters of burst blocks sent from the base station respectively to the relay station attached to the base station and the mobile station, the parameters point at burst blocks at a same position or different positions;
in the base station uplink direction, different information elements in an uplink map message of the base station frame structure are employed to indicate parameters of burst blocks sent to the base station respectively from the relay station attached to the base station and the mobile station; the parameters point at bust blocks at a same position or different positions;
in the relay station downlink direction, relay data parameters forwarded by the relay station to the mobile station are indicated by information elements in a relay station downlink map message or relay information elements in a downlink map message of the base station frame structure; and
in the relay station uplink direction, relay data parameters forwarded by the relay station from the mobile station to the base station are indicated by information elements in a relay station uplink map message or relay information elements in an uplink map message of the base station frame structure.

12. The method according to claim 8, wherein, when the mobile station is to be switched between the different relay stations attached to the base station, the service paths are configured as follows:
in the base station downlink direction, the base station sends same data to the different relay stations, and different map information elements in a downlink map message of a base station frame structure are employed to indicate parameters of burst blocks sent from the base station respectively to the different relay stations attached to the base station, the parameters point at burst blocks at a same position or different positions;
in the base station uplink direction, different information elements in an uplink map message of the base station frame structure are employed to indicate parameters of burst blocks sent to the base station respectively from the different relay stations attached to the base station; the parameters point at bust blocks at a same position or different positions;
in the relay station downlink direction, relay data parameters forwarded by the relay stations to the mobile station are indicated by information elements in a relay station downlink map message or relay information elements in a downlink map message of the base station frame structure, the relay data parameters forwarded by the different relay stations to the mobile station point at burst blocks at a same position or different positions; and
in the relay station uplink direction, relay data parameters forwarded by the relay station from the mobile station to the base station are indicated by information elements in a relay station uplink map message or relay information elements in an uplink map message of the base station frame structure, the relay data parameters forwarded by the relay station from the mobile station to the base station point at burst blocks at a same position or different positions.
